(19) United States
(12) Patent Application Publication
(10) Pub. No.: US 2014/0279818 A1
(43) Pub. Date: Sep. 18, 2014

(54) GAME THEORY MODEL FOR PATROLLING AN AREA THAT ACCOUNTS FOR DYNAMIC UNCERTAINTY

(71) Applicants: Albert Xin Jiang, Los Angeles, CA (US); Zhengyu Yin, Torrance, CA (US); Chao Zhang, Los Angeles, CA (US); Milind Tambe, Rancho Palos Verdes, CA (US); Sarit Kraus, Givat Shemuel (IL)

(72) Inventors: Albert Xin Jiang, Los Angeles, CA (US); Zhengyu Yin, Torrance, CA (US); Chao Zhang, Los Angeles, CA (US); Milind Tambe, Rancho Palos Verdes, CA (US); Sarit Kraus, Givat Shemuel (IL)

(73) Assignee: UNIVERSITY OF SOUTHERN CALIFORNIA, Los Angeles, CA (US)

(21) Appl. No.: 14/216,449

(22) Filed: Mar. 17, 2014

Related U.S. Application Data
(60) Provisional application No. 61/790,360, filed on Mar. 15, 2013.

(51) Int. Cl. G06N 5/04

(52) U.S. Cl. CPC G06N 5/048
USPC 706/52

(57) ABSTRACT

Game theory models may be used for producing a strategy and schedule for patrolling an area like a rail transportation system. In some instances, the model may account for events that cause a patrol unit to deviate from a patrol schedule and route. For example, a patrol schedule may be generated for one or more patrol units using a Bayesian Stackelberg game theory model based on a map of the public transportation system, a schedule of the transports, a list of the one or more patrolling units, a probability distribution for the occurrence of the passenger not paying to ride the transports, a list of the one or more possible events that would delay the patrol units, and a probability distribution for the occurrence of the one or more possible events that would delay the patrolling units represented by a Markov-decision process.

### CROSS-REFERENCE TO RELATED APPLICATION

This application is based upon and claims priority to U.S. provisional patent application 61/790,360, entitled “Game-Theoretic Randomization for Security Patrolling with Dynamic Execution Uncertainty,” filed Mar. 15, 2013, attorney docket number 028080-0863. The entire content of this application is incorporated herein by reference.

### STATEMENT REGARDING FEDERALLY SPONSORED RESEARCH

This invention was made with Government support under Grant No. MURI: W911NF-11-1-0332, awarded by the Transportation Security Administration (TSA). The Government has certain rights in the invention.

### BACKGROUND

1. Technical Field

This disclosure relates to game theory models.

2. Description of Related Art

Generally, security agencies have limited resources, which may result in not being able to cover or patrol all of the potential targets for attack all the time. Additionally, in some instances, attackers may be able to observe and learn the strategies of the security agency for patrolling the potential targets. Therefore, a deterministic or set schedule of patrols and patrol routes may be exploited by an attacker. In some instances, game theory has been used for developing patrol schedules and routes that address these issues.

In game theory models, timing may be an integral part of what determines the effectiveness of patrol schedules, in addition to the set of targets to be covered. For example, trains, flights, and ferries follow specific schedules, and in order to protect them a patroller should to be at the right place at the right time. In such domains, events may occur that affect the patroller's ability to execute the remaining portion of the patrol on schedule (e.g., errors, emergencies, arrests, and noise). These interruptions in the patrol schedule and route are sometimes referred to as execution uncertainties.

There has been previous research on execution uncertainty modeling and robust strategy computation in Stackelberg games. In many instances, this research has focused on one shot games in which the defender's (or patroller's) only objective is a single action rather than a series of actions or events that exist in a patrol schedule and route.

### SUMMARY

This disclosure relates to game theory models for patrolling an area like a rail transportation system, where the model accounts for events that cause a patrol unit to deviate from a patrol schedule and route.

Some embodiments may include a non-transitory, tangible, computer-readable storage medium containing a program of instructions that cause a computer system running the program of instructions to: receive a map of a public transportation system to be patrolled, a schedule of transports for the public transportation system, a list of one or more patrolling units available for patrolling the public transportation system, a probability distribution for an occurrence of a passenger not paying to ride the transports of the public transportation system, a list of one or more possible events that would delay the patrolling units during a patrol, a probability distribution for an occurrence of the one or more possible events that would delay the patrolling units; and generate a patrol schedule for each patrol unit using a Bayesian Stackelberg game theory model based on the map of the public transportation system, the schedule of the transports, the list of the one or more patrolling units, the probability distribution for the occurrence of the passenger not paying to ride the transports, the list of the one or more possible events that would delay the patrolling units, the probability distribution for the occurrence of the one or more possible events that would delay the patrolling units, wherein the probability distribution for the occurrence of the one or more possible events that would delay the patrolling units is represented by a Markov-decision process.

Some embodiments may include a non-transitory, tangible, computer-readable storage medium containing a program of instructions that cause a computer system running the program of instructions to: receive a map of an area to be patrolled, a list of patrolling units available for patrolling the area, a description of maneuverability of each of the patrolling units, a description of a possible attack or attacks, a list of routes for an attacker corresponding to each possible attack, a probability distribution for each possible attack and corresponding routes for the attacker, a list of one or more possible events that would delay the patrolling units during a patrol, a probability distribution for an occurrence of the one or more possible events that would delay the patrolling units; and generate a patrol schedule for each patrol unit using a Bayesian Stackelberg game theory model based on the map of the area, the list of patrolling units, the description of maneuverability of each of the patrolling units, the description of the possible attack or attacks, the list of routes for the attacker corresponding to each possible attack, the probability distribution for each possible attack and corresponding routes for the attacker, the list of the one or more possible events that would delay the patrolling units, the probability distribution for the occurrence of the one or more possible events that would delay the patrolling units, wherein the probability distribution for the occurrence of the one or more possible events that would delay the patrolling units is represented by a Markov-decision process.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an exemplary Markov decision process (MDP) for a defender unit in a patrolling game.

FIGS. 2A-2H illustrate the results of a patrolling game according to at least one embodiment described herein applied to an LA Metro rail system.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

In some embodiments, the present application provides for a program of instructions for generating a patrol schedule and route for a patrol unit(s) using a Bayesian Stackelberg game theory model where execution uncertainties (i.e., events may occur that affect the patrol unit's ability to execute the remaining portion of the patrol on schedule) are represented by a Markov-decision process.

In some embodiments, the program of instructions may be configured to receive information that is used in the game theory model (also referred to herein as a patrolling game). Examples of information that may be useful for executing the game theory model may include, but are not limited to, a map of the area to be patrolled (e.g., a route map of a transportation system or a map of trails, roads, and the like for a system of lakes and wooded areas), a list of patrolling units available for patrolling the area (e.g., officers on foot, officers on horseback, officers in vehicles, and unmanned aerial vehicles), a description of the maneuverability of each of the patrolling units (e.g., the routes available to a patrolling unit and the speed at which a patrolling unit can move along a route), a description of a possible attack or attacks (e.g., bombing a building, riding the subway without paying, illegally crossing a border, illegal hunting (poaching), and illegally cutting down trees), a list of routes for an attacker corresponding to each possible attack, a probability distribution for each possible attack and corresponding routes for the attacker, a list of a possible execution uncertainty(s) for each of the patrolling units, a probability distribution for each possible execution uncertainty, and any combination thereof. Additional information may be useful for specific patrolling game scenarios depending on the area to be patrolled, the patrolling units available, and the types of attacks being considered. For example, when modeling a public transportation system (e.g., a metro rail system), a schedule of transports (e.g., trains) for the transportation system may be useful.

In some embodiments, a patrolling game with execution uncertainty describe herein may be a two-player Bayesian Stackelberg game between a leader (the defender) and a follower (the adversary). The leader has γ patrol units (also referred to herein as units or defender units) and commits to a randomized daily patrol schedule for each patrol unit. Each patrol schedule may consist of a list of commands to be carried out in sequence. Each command may be in the form: at time T, the patrol unit should be at location l, and should execute patrol action a. The patrol action a of the current command, if executed successfully, may take the unit to the location and time of the next command. The patrolling game may allow for each patrol unit to face at least one execution uncertainty for each command (e.g., missing a scheduled train that takes the patrolling unit from one location to another, responding to a call at a different location, issuing a citation for an illegal behavior, and responding to an emergency). As a result the unit may end up at a location and a time that is different from the intended outcome of the patrol action a.

In some embodiments, a Markov decision process (MDP) may be used as a compact representation to model each individual defender unit's execution of patrols. These MDPs are not the whole game: they only model the defender's interactions with the environment when executing patrols. The interaction between the defender and the adversary is discussed further herein. Formally, for each defender unit iε{1, . . . , γ}, a MDP (Sᵢ, Aᵢ, Tᵢ, Rᵢ) is defined, where
Sᵢ is a finite set of states. Each state sᵢεSᵢ is a tuple (l, T) of the current location of the unit and the current discretized time. I(sᵢ) and T (sᵢ) are denoted as the location and time of sᵢ, respectively.
Aᵢ is a finite set of actions. Let Aᵢ (sᵢ)⊂Aᵢ be the set of actions available at state sᵢ.
For each sᵢεSᵢ and each action aᵢεAᵢ (s), the default next state n(sᵢ, aᵢ)εSᵢ is the intended next state when executing action aᵢ at sᵢ. A transition (sᵢ, aᵢ, sᵢ′) is a default transition if sᵢ=n(sᵢaᵢ) and is a non-default transition otherwise.
Tᵢ (sᵢ, aᵢ, sᵢ′) is the probability of next state being sᵢ′ if the current state is s and the action taken is aᵢ.
Rᵢ (sᵢ, aᵢ, sᵢ′) is the immediate reward for the defender from the transition (sᵢ, aᵢ, sᵢ′). For example, being available for emergencies (such as helping a lost child) is an important function of the police, which may be taken into account in an optimization formulation by using Rᵢ to give positive rewards for such events.

This exemplary MDP is acyclic: Tᵢ (sᵢ, aᵢ, sᵢ′) is positive only when T (sᵢ)>T (sᵢ), i.e., all transitions go forward in time. Sᵢ⁺⊂Sᵢ is the subset of states where a patrol may start. A patrol may end at any state. For convenience, a dummy source state sᵢ⁺εSᵢ is added that has actions with deterministic transitions going into each of the states in Sᵢ⁺, and analogously a dummy sink state sᵢ⁻εSᵢ. Thus each patrol of defender i starts at sᵢ⁺ and ends at sᵢ⁻. A patrol execution of i is specified by its complete trajectory tᵢ=(sᵢ⁺, aᵢ⁺, sᵢ¹, aᵢ¹, sᵢ², . . . , sᵢ⁻), which records the sequence of states visited and actions performed. A joint complete trajectory, denoted by t=(t₁, . . . , t_{γ}), is a tuple of complete trajectories of all units. Let χ be the finite space of joint complete trajectories.

The immediate rewards Rᵢ may not be all the utility received by the defender. The defender also receives rewards from interactions with the adversary. The adversary can be of a set [symbol] of possible types and has a finite set of actions A. The types are drawn from a known distribution, with p_{λ} the probability of type λε [symbol] . The defender does not know the instantiated type of the adversary, while the adversary does and can condition his decision on his type.

In this general game model, the utilities resulting from defender-adversary interaction may depend arbitrarily on the complete trajectories of the defender units. Formally, for a joint complete trajectory t, the realized adversary type λε [symbol] , and an action of the adversary αεA, the defender receives utility u^{d}(t, λ, α), while the adversary receives u^{a}(t, λ, α).

The Strong Stackelberg Equilibrium (SSE) of this game may be found, in which the defender commits to a randomized policy which is defined next, and the adversary plays a best response to this randomized policy. It may be sufficient to consider only pure strategies for the adversary. In some instances, finding one SSE may be equivalent to the following optimization problem:

$$\begin{matrix}{max}_{π} {\sum }_{λ ∈ Λ} {p}_{λ} {E}_{t \sim π} [ {u}^{d} ( t , λ , {α}_{λ} ) + {\sum }_{i} {R}_{i} ( {t}_{i} ) ] & ( 1 ) \\ s . t . {α}_{λ} ∈ arg {max}_{{α}_{λ}} {E}_{t \sim π} [ {u}^{a} ( t , λ , {α}_{λ} ) ] , ∀ λ ∈ Λ & ( 2 )\end{matrix}$$

where Rᵢ(tᵢ) is the total immediate reward from the trajectory ti, and E_{t˜π}[·] denotes the expectation over joint complete trajectories induced by defender's randomized policy π.

Whereas MDPs always have Markovian and deterministic optimal policies, in the patrolling game described herein, the defender's optimal strategy may, in some instances, be non-Markovian because the utilities depend on trajectories and may be randomized because of interactions with the adversary. For example, two cases may be considered: coupled execution and decoupled execution. In coupled execution, patrol units can coordinate with each other; that is, the behavior of unit i at sᵢ may depend on the earlier joint trajectory of all units. Formally, let Tᵢ be the set of unit i's partial trajectories (sᵢ⁺, aᵢ⁺, sᵢ¹, aᵢ¹, . . . , sᵢ⁻). A coupled randomized policy may be a function π: ΠᵢTᵢ×ΠᵢAᵢ→ [symbol] that specifies a probability distribution over joint actions of units for each joint partial trajectory. Let φ(t; π)ε [symbol] be the probability that joint complete trajectory tεχ is instantiated under policy π. In decoupled execution, patrol units do not communicate with each other. Formally, a decoupled randomized policy π=(π₁, . . . , π_{γ}) where for each unit i, πᵢ: Tᵢ×Aᵢ→ [symbol] specifies a probability distribution over i's actions given each partial trajectory of i. Thus a decoupled randomized policy (πᵢ, . . . , π_{γ}) can be thought of as a coupled randomized policy π′ where π′(t, (a₁, . . . , a_{γ}))=Πᵢπᵢ(tᵢ, αᵢ).

In some instances, coupled execution may yield higher expected utility than decoupled execution. For example, suppose the defender wants to protect an important target with at least one patrol unit, and patrol unit 1 may be assigned that task. Then, if patrol unit 1 is dealing with an emergency and unable to reach that target, patrol unit 2 may be rerouted to cover the target. However, coordinating among units presents significant logistical and computational burden.

In instances where the defender's optimal strategy may be coupled and non-Markovian (i.e., the policy at s may depend on the entire earlier trajectories of all units rather than the current state s), solving the game may become computationally difficult because the dimension of the space of mixed strategies may be exponential in the number of states.

However, in some instances, the utilities of many domains may have additional structure. Under the assumption that the utilities have separable structure, it may be possible to efficiently compute an SSE of patrolling games with execution uncertainty.

### Efficient Computation Via Compact Representation of Strategies

Consider a coupled strategy π. Denote by xᵢ(sᵢ, aᵢ, sᵢ′) the marginal probability of defender unit i reaching state sᵢ, executing action aᵢ, and ending up at next state sᵢ′. Formally,

xᵢ(sᵢ,aᵢ,sᵢ′)=Σ_{tεχ}φ(t;π)θ(tᵢ,sᵢ,aᵢ,sᵢ′), (3)

where the value of the membership function θ(tᵢ, sᵢ, aᵢ, sᵢ′) is equal to 1 if trajectory ti contains transition (sᵢ, aᵢ, sᵢ′) and is equal to 0 otherwise. Let xεR^{M} be the vector of these marginal probabilities, where M=Σᵢ|Sᵢ|²|Aᵢ|. Similarly let wᵢ(sᵢ,aᵢ) be the marginal probability of unit i reaching sᵢ and taking action aᵢ. Let wε [symbol] ^{Σ}^{ᵢ}^{|S}^{ᵢ}^{∥A}^{ᵢ}^{|} be the vector of these marginal probabilities. w and x satisfy the linear constraints:

xᵢ(sᵢ,aᵢ,sᵢ′)=ωᵢ(sᵢ,aᵢ)Tᵢ(sᵢ,aᵢ,sᵢ′),∀sᵢ,aᵢ,sᵢ′ (4)

Σₛ_{ᵢ}_{′}xᵢ(sᵢ′,aᵢ′,sᵢ)=Σₐ_{ᵢ}ωᵢ(sᵢ,aᵢ),∀sᵢ (5)

Σₐ_{ᵢ}ωᵢ(sᵢ⁺,aᵢ)=Σₛ_{ᵢ}_{′,a}_{ᵢ}_{′}xᵢ(sᵢ′,aᵢ′,sᵢ⁺)=1, (6)

ωᵢ(sᵢ,aᵢ)≧0∀sᵢ,aᵢ (7)

Lemma 1: For all coupled randomized policy π, the resulting marginal probabilities wᵢ(sᵢ, aᵢ) and xᵢ(sᵢ, aᵢ, sᵢ′) satisfy constraints (4), (5), (6), (7).

Proof Sketch: Constraint (4) holds by the definition of transition probabilities of MDPs. Constraint (5) holds because both Ihs and rhs equal the marginal probability of reaching state s. Constraint (6) holds because by construction, the marginal probability of reaching sᵢ⁺ is 1, and so is the marginal probability of reaching sᵢ⁻. Constraint (7) holds because wᵢ(sᵢ, aᵢ) is a probability.

If utilities can be formulated in terms of w and x, which have dimensions polynomial in the sizes of the MDPs, this may lead to a much more compact representation of the SSE problem compared to (1). It turns out this may be possible if the game's utilities are separable, which may mean that given the adversary's strategy, the utilities of both players are sums of contributions from individual units' individual transitions:

Definition 1: A patrolling game with execution uncertainty as described herein has separable utilities if there exist utilities U_{λ}^{d}(sᵢ, aᵢ, sᵢ′, α) and U_{λ}^{a}(sᵢ, aᵢ, sᵢ′, α) for each unit i, transition (sᵢ, aᵢ, sᵢ′), λεΛ, αεA, αεA such that for all tεχ, λεΛ, αεA, the defender's and the adversary's utilities can be expressed as u^{d}(t,λ,α)=ΣᵢΣₛ_{ᵢ}_{,a}_{ᵢ}_{,s}_{ᵢ}_{′}θ(tᵢ, sᵢ, aᵢ, sᵢ′)U_{λ}^{d}(sᵢ, aᵢ, sᵢ′, α) and u^{a}(t, λ, α)=ΣᵢΣₛ_{ᵢ}_{,a}_{ᵢ}_{,s}_{ᵢ}_{′}θ(tᵢ, sᵢ, aᵢ, sᵢ′)U_{λ}^{α}(sᵢ, aᵢ, sᵢ′, α) respectively.

Let U_{λ}^{d}, U_{λ}^{a}ε [symbol] ^{M×|A}^{ᵢ}^{|} be the corresponding matrices. Then U_{λ}^{d}, U_{λ}^{a} completely specifies the utility functions u^{d} and u^{a}.

FIG. 1 illustrates an exemplary MDP for the defender unit in a patrolling game. There are six states, shown as circles in the FIG. 1, over two locations L₁, L₂ and three time points T₀, T₁, T₂. From states at T₀ and T₁, the unit has two actions: to stay at the current location, which always succeeds, and to try to go to the other location, which with probability 0.9 succeeds and with probability 0.1 fails (in which case it stays at the current location). There are 12 transitions in total, which is fewer than the number of complete trajectories (18). In this example, there is a single type of adversary who chooses one location between L₁ and L₂ and one time point between T₁ and T₂ to attack (T₀ cannot be chosen). If the defender is at that location at that time, the attack fails and both players get zero utility. Otherwise, the attack succeeds, and the adversary gets utility 1 while the defender gets −1. In other words, the attack succeeds if and only if it avoids the defender unit's trajectory. In some instances, it may be straightforward to verify that this game has separable utilities: for any transition (sᵢ, aᵢ, sᵢ′) in the MDP, let U_{λ}^{a}(sᵢ, aᵢ, sᵢ′, α) be 1 if a coincides with sᵢ′ and 0 otherwise. For example, the utility expression for the adversary given trajectory ((L₁, T₀), To L₂, (L₁, T₁), To L₂, (L2, T₂)) is U_{λ}^{a}((L₁, T₀), To L₂, (L₁, T₁), α)+U_{λ}^{a}((L₁, T₁), To L₂, (L₂, T₂), α), which gives the correct utility value for the adversary: 1 if a equals (L₁, T₁) or (L₂, T₂) and 0 otherwise.

Lemma 2: Consider a game with separable utilities. Suppose x is the vector of marginal probabilities induced by the defender's randomized policy π. Let y_{λ}ε [symbol] ^{A|} be a vector describing the mixed strategy of the adversary of type λ, with γ_{λ}(α) denoting the probability of choosing action α. Then the defender's and the adversary's expected utilities from their interactions are Σ_{λ}p_{λ}x^{T}U_{λ}^{d}y_{λ} and Σ_{λ}p_{λ}x^{T}U_{λ}^{α}y_{λ}, respectively.

In other words, given the adversary's strategy, the expected utilities of both players may be linear in the marginal probabilities xᵢ(sᵢ, aᵢ, sᵢ′). Lemma 2 also applies when (as in an SSE) the adversary is playing a pure strategy, in which case y_{λ} is a 0-1 integer vector with y_{λ}(α)=1 if α is the action chosen. This compact representation of defender strategies can be used to rewrite the formulation for SSE (1) as a polynomial-sized optimization problem.

max_{w,x,y}Σ_{λεΛ}p_{λ}x^{T}U_{λ}^{d}y_{λ}+Σᵢ₌₁^{γ}Σₐ_{ᵢ}_{,s}_{ᵢ}_{′}xᵢ(sᵢ,aᵢ,sᵢ′)Rᵢ(sᵢ,aᵢ,sᵢ′) (8)

Σ_{α}y_{λ}(α)=1,y_{λ}(α)ε{0,1} (9)

y_{λ}εarg max_{y′}_{_{λ}}x^{T}U_{λ}^{a}y_{λ}′ (10)

Given a solution w, x to (8), a decoupled policy can be computed that matches the marginals w, x. Compared to (1), the optimization problem (8) has exponentially fewer dimensions; in particular the numbers of variables and constraints may be polynomial in the sizes of the MDPs.

For the special case of U_{λ}^{d}+U_{λ}^{a}=0 for all λ (i.e., when the interaction between defender and adversary is zero-sum) the above SSE problem can be formulated as a linear program (LP)

max_{w,x,u}Σ_{λεΛ}p_{λ}u_{λ}+ΣᵢΣₛ_{ᵢ}_{,a}_{ᵢ}_{,s}_{ᵢ}_{′}xᵢ(sᵢ,aᵢ,sᵢ′)Rᵢ(sᵢ,aᵢ,sᵢ′) (11)

u_{λ}≦x^{T}U_{λ}^{d}e_{α},∀λεΛ,αεA, (12)

where e_{α} is the basis vector corresponding to adversary action α. This LP is similar to the maximin LP for a zero-sum game with the utilities given by U_{λ}^{d} and U_{λ}^{a}, except that an additional term ΣᵢΣₛ_{ᵢ}_{,a}_{ᵢ}_{,s}_{ᵢ}_{′}xᵢ(sᵢ, aᵢ, sᵢ′)Rᵢ(sᵢ, aᵢ, sᵢ′) representing defender's expected utilities from immediate rewards may be added to the objective. One potential issue may arise: because of the extra defender utilities from immediate rewards, the entire game is no longer zero-sum. Is it still valid to use the above maximin LP formulation? It turns out that the LP is indeed valid, as the immediate rewards do not depend on the adversary's strategy.

Proposition 1. If the game has separable utilities and U_{λ}^{d}+U_{λ}^{a}=0 for all λ, then a solution of the LP (11) is an SSE.

Proof Sketch: This game can be transformed to an equivalent zero-sum Bayesian game whose LP formulation is equivalent to (11). Specifically, given the non-zero-sum Bayesian game r specified above, consider the Bayesian game Γ′ with the following “meta” type distribution for the second player: for all λεΛ of Γ there is a corresponding type λ′εΛ′ in Λ′, with probability p_{λ},=0.5p_{λ}, with the familiar utility functions; and there is a special type φεΛ′ with probability p_{φ}=0.5, whose action does not affect either player's utility. Specifically the utilities under the special type φ are u^{d}(t, φ, α)=ΣᵢΣₛ_{ᵢ}_{,a}_{ᵢ}_{,s}_{ᵢ}_{′}θ(tᵢ, sᵢ, aᵢ, sᵢ′)Rᵢ(sᵢ, aᵢ, sᵢ′) and u^{a}(t, φ, α)=−Σ_{ᵢ}_{,s}_{ᵢ}_{,a}_{ᵢ}_{,s}_{ᵢ}_{′}θ(tᵢ, sᵢ, aᵢ, sᵢ′)Rᵢ(sᵢ, aᵢ, sᵢ′). The resulting game Λ′ is zero-sum, with the defender's utility exactly half the objective of (11). Since for zero-sum games maximin strategies and SSE coincide, a solution of the LP (11) is an optimal SSE marginal vector for the defender of Λ′. On the other hand, the only difference between the induced normal forms of Λ and Λ′ is that for the adversary the utility −0.5 Σ_{eεE*}Uₑxₑ is added, which does not depend on the adversary's strategy. Therefore Λ and Λ′ have the same set of SSE, which implies that a solution of the LP is an SSE of Λ.

Regarding, generating patrol schedules, the solution of (8) does not yet provide a complete specification of what to do. For example, a Markov strategy π is defined to be a decoupled strategy (π₁, . . . , π_{γ}), πᵢ: Sᵢ×Aᵢ→R, where the distribution over next actions depends only on the current state. Proposition 2 below shows that given w, x, there is a simple procedure to calculate a Markov strategy that matches the marginal probabilities. This implies that if w, x is the optimal solution of (8), then the corresponding Markov strategy nr achieves the same expected utility. For games with separable utilities it is sufficient to consider Markov strategies.

Proposition 2: Given w,x satisfying constraints (4) to (7), construct a Markov strategy π as follows: for each sᵢεSᵢ, for each aᵢεAᵢ(sᵢ),

$${π}_{i} ( {s}_{i} , {a}_{i} ) = \frac{{w}_{i} ( {s}_{i} , {a}_{i} )}{{\sum }_{{a}_{i}^{′}} {w}_{i} ( {s}_{i} , {a}_{i}^{′} )} .$$

Suppose the defender plays π, then for all unit i and transition (sᵢ, aᵢ, sᵢ′), the probability that (sᵢ, aᵢ, sᵢ′) is reached by i equals xᵢ(sᵢ, aᵢ, sᵢ′).

Proof Sketch: Such a Markov strategy nr induces a Markov chain over the states Sᵢ for each unit i. It can be verified by induction that the resulting marginal probability vector matches x. In practice, directly implementing a Markov strategy requires the unit to pick an action according to the randomized Markov strategy at each time step. This may be possible when units can consult a smart phone app that stores the strategy, or can communicate with a central command. However, in certain domains such requirement on computation or communication at each time step places additional logistical burden on the patrol unit. To avoid unnecessary computation or communication at every time step, it may be desirable to have a deterministic schedule (i.e., a pure strategy) from the Markov strategy. With no execution uncertainty, a pure strategy can be specified by the a complete trajectory for each unit. However, this no longer works in the case with execution uncertainty.

To begin, a Markov pure strategy is defined, which specifies a deterministic choice at each state.

Definition 2: A Markov pure strategy q is a tuple (q₁, . . . , q_{γ}) where for each unit i, qᵢ: Sᵢ→Aᵢ.

Given a Markov strategy π, a Markov pure strategy q may be sampled as follows: for each unit i and state sᵢεSᵢ, sample an action aᵢ as qᵢ(sᵢ) according to πᵢ. This procedure is correct since each state in i's MDP is visited at most once and thus qᵢ exactly simulates a walk from sᵢ⁺ on the Markov chain induced by πᵢ.

To directly implement a Markov pure strategy, the unit needs to remember the entire mapping q or receives the action from the central command at each time step. A logistically more efficient way may be for the central command to send the unit a trajectory assuming perfect execution, and only after a non-default transition happened does the unit communicates with the central command to get a new trajectory starting from the current state. Formally, given sᵢεSᵢ and qᵢ, the optimistic trajectory from sᵢ induced by qᵢ is (sᵢ; qᵢ (sᵢ); n(sᵢ; qᵢ (sᵢ)); : : : s⁻), i.e, the trajectory assuming it always reaches its default next state. Given a Markov pure strategy q, the following procedure for each unit i exactly simulates q: (i) central command gives unit i the optimistic trajectory from s⁺ induced by qᵢ; (ii) unit i follows the trajectory until the terminal state s⁻ is reached or some unexpected event happens and takes i to state sᵢ′; (iii) central command sends the new optimistic trajectory from sᵢ′ induced by qᵢ to unit i and repeat from step (ii).

### Coupled Execution: Cartesian Product MDP

Without the assumption of separable utilities, it may no longer sufficient to consider decoupled Markov strategies of individual units' MDPs. A new MDP may be created that captures the joint execution of patrols by all units. For simplicity of exposition, an example case with two defender units is described herein. One of skill in the art would recognize how to expand this example to additional defender units. Then, a state in the new MDP corresponds to the tuple (location of unit 1, location of unit 2, time). An action in the new MDP corresponds to a tuple (action of unit 1, action of unit 2). Formally, if unit 1 has an action a₁ at state s₁=(l₁, T) that takes unit 1 to s₁′=(l₁′, T′) with probability T₁(s₁, a₁, s₁′), and unit 2 has an action a₂ at state s₂=(l₂, T) that takes unit 2 to s₂′=(l₂′, T′) with probability T₂(s₂, a₂, s₂′), in the new MDP an action aₓ=(a₁, a₂) may be created from state sₓ=(l₁, l₂, T) that transitions to sₓ′=(l₁′, l₂′, T′) with probability Tₓ (sₓ, aₓ, sₓ′)=T₁ (s₁, a₁, s₁′) T₂ (s₂, a₂, s₂′). In some instances, the immediate rewards Rₓ of the MDP may be defined analogously. The resulting MDP (Sₓ, Aₓ, Tₓ, Rₓ) is the Cartesian Product MDP.

An issue arises when at state sₓ the individual units have transitions of different time durations. For example, unit 1 rides a train that takes 2 time steps to reach the next station while unit 2 stays at a station for 1 time step. During these intermediate time steps only unit 2 has a “free choice”. One approach for modelling this on a Cartesian Product MDP may be to create new states for the intermediate time steps. For example, suppose at location L_{A} at time 1 a non-default transition takes unit 1 to location L_{A} at time 3. Unit 1's MDP may be changed so that this transition ends at a new state (L_{A}¹, 2)εS₁, where L_{A}¹ is a “special” location specifying that the unit may become alive again at location L_{A} in one more time step. There may be only one action from (L_{A}¹, 2), with only one possible next state (L_{A}¹, 3). Once \ the individual units' MDPs have been modified so that all transitions take exactly one time step, the Cartesian Product MDP may be created as described in the previous paragraph.

Like the units' MDPs, the Cartesian Product MDP may also acyclic. Therefore, marginal probabilities wₓ(sₓ, aₓ) and xₓ(sₓ, aₓ, sₓ′) may be defined on the Cartesian Product MDP. Let wₓε [symbol] ^{s}^{ₓ}^{∥A}^{ₓ}^{|} and xₓε [symbol] ^{|S}^{ₓ}^{|}^{²}^{|A}^{ₓ}^{|} be the corresponding vectors. Utilities generally cannot be expressed in terms of wₓ and xₓ. A special case may be considered in which utilities are partially separable:

Definition 3: A patrolling game with execution uncertainty has partially separable utilities if there U_{λ}^{d}((sₓ, aₓ, sₓ′, α) and U_{λ}^{a}(sₓ, aₓ, sₓ′, α) for each transition (sₓ, aₓ, sₓ′), λε [symbol] , αεA, such that for all tεχ, λε [symbol] , αεA, the defender's and the adversary's utilities can be expressed as u^{d}(t, λ, α)=Σₛ_{ₓ}_{,a}_{ₓ}ₛ_{ₓ}_{′}θₓ (t, sₓ, aₓ, sₓ′)U_{λ}^{d}(sₓ, aₓ, sₓ′, α) and u^{a}(t, λ, α)=Σₛ_{ₓ}_{,a}_{ₓ}ₛ_{ₓ}_{′}θₓ (t, sₓ, aₓ, sₓ′)U_{λ}^{a}(sₓ, aₓ, sₓ, ′, α), respectively.

Partially separable utilities may be a weaker condition than separable utilities, as now the expected utilities may not be sums of contributions from individual units. When utilities are partially separable, expected utilities can be expressed in terms of wₓ and xₓ and an SSE is found by solving an optimization problem analogous to (8). A Markov strategy

$${π}_{x}^{*} ( {s}_{x} , {a}_{x} ) = \frac{{ω}_{x}^{*} ( {s}_{x} , {a}_{x} )}{{\sum }_{{a}_{x}^{′}} {π}_{x}^{*} ( {s}_{x} , {a}_{x}^{′} )}$$

can be computed from the optimal wₓ*, which is provably the optimal coupled strategy.

In some instances, this approach may be difficult to scale up to a large number of defender units as the size of Sₓ and Aₓ grow exponentially in the number of units. In particular the dimension of the Markov policy πₓ is already exponential in the number of units. To overcome this a more compact representation of defender strategies may be needed. One approach may be to use decoupled strategies. Although this may not be optimal in general, the approach may give a good approximation as illustrated in the following example applied to the LA Metro domain.

### Example: Application of a Patrolling Game Described Herein to the LA Metro

This example applies patrolling gaming models described herein to the LA Metro domain. Although the utilities in this domain are not separable, by upper bounding the defender utilities by separable utilities, efficient computation may be achieved.

A state (i.e., the status of a patrol unit) here comprises the current station and time of a patrol unit, as well as necessary history information such as starting time. At any state, a unit may stay at the current station to conduct an in-station operation for some time or may ride a train to conduct an on-train operation when the current time coincides with the train schedule. Due to execution uncertainty, a unit may end up at a state other than the intended outcome of the action. For ease of analysis, the unexpected event delays a patrol unit for some time beyond the intended execution time. Specifically, for any fare check operation taken, there may be a probability η that the operation may be delayed, i.e., staying at the same station (for in-station operations) or on the same train (for on-train operations) involuntarily for some time. Furthermore, units may be involved with events unrelated to fare enforcement and thus may not check fares during any delayed period of an operation. Accordingly, a higher chance of delay may lead to less time spent on fare inspection.

The adversary faced in this example are the riders in the system. There are multiple types of riders, each is assumed to take a fixed route. In this example, a rider may observe the likelihood of being checked and make a binary decision between buying and not buying the ticket. If the rider of type λ buys the ticket, the rider pays a fixed ticket price ρ_{λ}. Otherwise, the rider rides the train for free but risks the chance of being caught and paying a fine of δ_{λ}>ρ_{λ}. In this example, the LA Sheriff's Department's (LASD) objective is set to maximize the overall revenue of the whole system including ticket sales and fine collected, essentially forming a zero-sum game.

In this example, since the fare-check operation performed is determined by the actual transition rather than the action taken, the effectiveness of a transition (s, a, s′) against a rider type λ is defined as f_{λ}(s, a, s′), as the percentage of riders of type λ checked by transition (s, a, s′). The probability that a joint complete trajectory t detects evader λ as the sum of f_{λ} over all transitions in t=(t₁, . . . , t_{γ}) capped at one:

Pr(t,λ)=min{Σᵢ₌₁^{γ}Σₛ_{ᵢ}_{,a}_{ᵢ}_{,s}_{ᵢ}_{′f}_{λ}(sᵢ,aᵢ,sᵢ′)θ(sᵢ,aᵢ,sᵢ′),1}. (3)

For type λ and joint trajectory t, the LASD receives ρ_{λ} if the rider buys the ticket and δ_{λ}·Pr(t, λ) otherwise. The utilities in this domain are indeed not separable—even though multiple units (or even a single unit) may detect a fare evader multiple times, the evader can only be fined once. As a result, neither players' utilities can be computed directly using marginal probabilities x and w. Instead, the defender utility is limited by overestimating the detection probability using marginals as the following:

P [symbol] =Σᵢ₌₁^{γ}Σₛ_{ᵢ}_{,a}_{ᵢ}_{,s}_{ᵢ}_{′}f_{λ}(sᵢ,aᵢ,sᵢ′)xᵢ(sᵢ,aᵢ,sᵢ′). (14)

Equation (14) leads to the following upper bound LP for the LA Metro problem:

max_{w,x,u}Σ_{λεΛ}p_{λ}u_{λ}+ΣᵢΣₛ_{ᵢ}_{,a}_{ᵢ}_{,s}_{ᵢ}_{′}Rᵢ(sᵢ,aᵢ,sᵢ′) (15)

u_{λ}≦min{ρ_{λ},ρ_{λ}P [symbol] }, for all ∀λεΛ (16)

The claim above may be proven by Proposition 3 and 4 as follows.

Proposition 3: P [symbol] is an upper bound of the true detection probability of any coupled strategy with marginals x.

Proof Sketch: Consider a coupled strategy π. Recall φ(t; π)ε [symbol] is the probability that joint trajectory tεχ is instantiated. For rider type λ, the true detection probability is Pr(π,λ)=Σ_{tεχ}φ(t; π)Pr(t,λ). Applying Equations (13) and (3),

$$\begin{matrix}Pr ( t , λ ) \leq {\sum }_{t ∈ χ} ϕ ( t ; π ) {\sum }_{i = 1}^{γ} {\sum }_{{s}_{i} , {a}_{i} , {s}_{i}^{′}} {f}_{λ} ( {s}_{i} , {a}_{i} , {s}_{i}^{′} ) θ ( {t}_{i} , {s}_{i} , {a}_{i} , {s}_{i}^{′} ) \\ = {\sum }_{i = 1}^{γ} {\sum }_{{s}_{i} , {a}_{i} , {s}_{i}^{′}} {f}_{λ} ( {s}_{i} , {a}_{i} , {s}_{i}^{′} ) {\sum }_{t ∈ χ} ϕ ( t ; π ) θ ( {t}_{i} , {s}_{i} , {a}_{i} , {s}_{i}^{′} ) \\ = {\sum }_{i = 1}^{γ} {\sum }_{{s}_{i} , {a}_{i} , {s}_{i}^{′}} {f}_{λ} ( {s}_{i} , {a}_{i} , {s}_{i}^{′} ) {x}_{i} ( {s}_{i} , {a}_{i} , {s}_{i}^{′} ) \\ = \hat{Pr ( t , λ )}\end{matrix}$$

Proposition 4: LP (15) provides an upper bound of the optimal coupled strategy.

Proof Sketch: Let x* and w* be the marginal coverage and u_{λ}* be the value of the patroller against rider type λ in the optimal coupled strategy π*. It suffices to show that x*, w*, and u* is a feasible point of the LP. From Lemma 1, x* and w* must satisfy constraints (4) to (7). Furthermore, u_{λ}*≦ρ_{λ} since the rider pays at most the ticket price. Finally, u_{λ}*≦ρ_{λ}·P [symbol] ) since P [symbol] is an overestimate of the true detection probability.

LP (15) relaxes the utility functions by allowing an evader to be fined multiple times during a single trip. The relaxed utilities are separable and thus the relaxed problem can be efficiently solved. Since the solution returned x* and w* satisfy constraints (4) to (7), a Markov strategy can be constructed from w*. The Markov strategy provides an approximate solution to the original problem, whose actual value can be evaluated using Monte Carlo simulation.

The evaluation is based on real metro schedules and rider traffic data provided by the LASD. LP (15) is solved using CPLEX 12.2 with the barrier method on standard 2.8 GHz machines with 4 GB memory. Each Markov strategy induced from the LP solution was evaluated using Monte Carlo simulation with 100,000 samples. Riders were assumed to choose a best response based on the frequency of being checked over these samples.

Data sets were provided based on different Los Angeles Metro Rail lines: Red (including Purple), Blue, Gold, and Green. In these data sets, the train schedules were obtained from http://www.metro.net and the ridership distributions were estimated from hourly boarding and alighting counts provided by the LASD. Any on-train operations are allowed while in-station operations are restricted to be between half an hour and an hour, as suggested by the LASD. The effectiveness of each fare check operation was adjusted based on the volume of riders during the period with an assumption that a unit can check three riders per minute. The ticket fare was set to $1.5 while the fine was set to $100. The immediate rewards Rᵢ are all set to zero. Table 1 summarizes the detailed statistics for the four Metro lines.

TABLE 1

| Line | Stops | Trains | Daily Riders | Types |
|---|---|---|---|---|
| Red | 16 | 433 | 149991.5 | 26033 |
| Blue | 22 | 287 | 76906.2 | 46630 |
| Gold | 19 | 280 | 30940.0 | 41910 |
| Green | 14 | 217 | 38442.6 | 19559 |

The performance of the Markov strategies described herein was studied under a variety of settings. FIGS. 2A-2H illustrate the results of a patrolling game according to at least one embodiment described herein applied to an LA Metro rail system.

Throughout the settings, the Markov strategy was close to optimal with revenue always above 99% of the LP upper bound. In the remainder of this subsection, values of the Markov strategy are reported without mentioning the LP upper bound. Given space limits, in some cases, only results for the Red line are presented, but other lines were also tested and showed similar results.

In the first set of experiments, the performance of a Markov strategy against pre-generated schedules given by TRUSTS, a deterministic model assuming perfect execution, under execution uncertainty are compared. However, actions to take after deviations from the original plan are not well defined in TRUSTS schedules, making a direct comparison inapplicable. Therefore, these pre-generated schedules are changed with two naive contingency plans indicating the actions to follow after a unit deviates from the original plan. The first plan, “Abort”, is to simply abandon the entire schedule and return to the base. The second plan, “Arbitrary”, is to pick an action uniformly randomly from all available actions at any decision point after the deviation.

In this experiment, the number of units is fixed to 6 and the patrol length to 3 hours, and presented the results on the Red line (experiments on other lines showed similar results). The delay time is fixed to 10 minutes and varied the delay probability η from 0% to 25%. As seen in FIG. 2A, both “Abort” and “Arbitrary” performed poorly in the presence of execution uncertainty. With increasing values of η, the revenue of “Abort” and “Arbitrary” decayed much faster than the Markov strategy. For example, when η was increased from 0% to 25%, the revenue of “Abort” and “Arbitrary” decreased 75.4% and 37.0% respectively while that of the Markov strategy only decreased 3.6%.

In addition to revenue, FIG. 2C showed the fare evasion rate of the three policies with increasing η. A rider prefer fare evasion if and only if his expected penalty from fare evasion is $0.2 lower than $1.5, the ticket price. “Abort” and “Arbitrary” showed extremely poor performance in evasion deterrence with even a tiny probability of execution error. In particular, when r was increased from 0% to 5%, the evasion rate of the Markov strategy barely increased while that of “Abort” and “Arbitrary” increased from 11.2% both to 74.3% and 43.9% respectively.

Then η is fixed to 10% and varied the delay time from 5 to 25 minutes. FIG. 2B showed that both “Abort” and “Arbitrary” performed worse than the Markov strategy. With increasing delay time, the revenue of “Abort” remained the same as the time of the delay really did not matter if the unit was to abandon the schedule after the first unexpected event. The revenue of “Arbitrary”, however, decayed in a faster rate than the Markov strategy. When the delay time was increased from 5 to 25 minutes, the revenue of “Abort” remained the same while that of “Arbitrary” and the Markov strategy decreased 14.4% and 3.6% respectively.

An important observation here is that the revenue of “Abort”, a common practice in fielded operations, decayed extremely fast with increasing η—even with a 5% probability of delay, the revenue of “Abort” was only 73.5% of that of the Markov strategy. With a conservative estimate of 6% potential fare evaders and 300,000 daily riders in the LA Metro Rail system, the 26.5% difference implies a daily revenue loss of $6,500 or $2.4 million annually.

In the second set of experiments, the Markov strategy performed well consistently in all of the four lines with increasing delay probability η. The number of units is fixed to 6 and the patrol length to 3 hours, but varied η from 0% to 25%. FIG. 2D and FIG. 2E showed the revenue per rider and the evasion rate of the four lines respectively. The revenue decreased and the evasion rate increased with increasing η. However, the Markov strategy was able to effectively allocate resources to counter the effect of increasing η in terms of both revenue maximization and evasion deterrence. For example, the ratio of the revenue of η=25% to that of η=0% was 97.2%, 99.1%, 99.9%, 95.3% in the Blue, Gold, Green and Red line respectively. Similarly, when η was increased from 0% to 25%, the evasion rate of the Blue, Gold, Green and Red line was increased by 4.6, 1.9, 0.1, 5.2 percentage points respectively.

The next experiment showed that the revenue decay of the Markov strategy with respect to delay probability η may be affected by the amount of resources devoted to fare enforcement. In FIG. 2F, the revenue per rider with increasing η on the Red line only, but the same trends were found on the other three lines. In this experiment, 3, 6 and 9 patrol units are considered, representing three levels of fare enforcement: low, medium, and high respectively. With more resources, the defender may better afford the time spent on handling unexpected events without sacrificing the overall revenue. The rate of revenue decay with respect to q decreased as the level of fare enforcement increases from low to high. For example, when η was increased from 0% to 25%, the revenue drop in the low, medium and high enforcement setting was 13.2%, 4.7%, and 0.4% respectively.

Next, the usefulness of a Markov strategy is shown in distributing resources under different levels of uncertainty. Results on the Red line with a fixed patrol length of 3 hours are shown. Three delay probabilities η=0%, 10%, and 20% were considered, representing increasing levels of uncertainty. FIG. 2G showed the revenue per rider with increasing number of units from 2 to 6. As the number of units increased, the revenue increased towards the maximal achievable value of $1.5-(ticket price). For example, when q=10%, the revenue per rider was $0.65, $1.12, and $1.37 with 2, 4, and to 6 patrol units respectively.

Finally, FIG. 2H plotted the worst-case runtime (over 10 runs) of the LP with increasing q for the four metro lines. The number of units was fixed to 3 and the patrol length per unit was fixed to 3 hours. All of the problems can be solved within an hour. The runtime varied among the four Metro lines and correlated to their number of states and types. For example, when η=10%, the runtime for the Blue, Gold, Green, and Red line was 14.0, 24.3, 2.4, and 4.3 minutes respectively. Surprisingly, for all of the four lines, stochastic models with η=5% took less time to solve than deterministic models (η=0%). Overall no direct correlation between the runtime and delay probability η.

Unless otherwise indicated, the program of instructions, game theory models, and algorithms that have been discussed herein are implemented with a computer system configured to perform the functions that have been described herein for the component. Each computer system includes one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Each computer system for, the program of instructions, game theory models, and algorithms may be a desktop computer or a portable computer, such as a laptop computer, a notebook computer, a tablet computer, a PDA, a smartphone, or part of a larger system, such a vehicle, appliance, and/or telephone system.

A single computer system may be shared by, the program of instructions, game theory models, and algorithms.

Each computer system for, the program of instructions, game theory models, and algorithms may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A non-transitory, tangible, computer-readable storage medium containing a program of instructions that cause a computer system running the program of instructions to:
receive a map of a public transportation system to be patrolled, a schedule of transports for the public transportation system, a list of one or more patrolling units available for patrolling the public transportation system, a probability distribution for an occurrence of a passenger not paying to ride the transports of the public transportation system, a list of one or more possible events that would delay the patrolling units during a patrol, a probability distribution for an occurrence of the one or more possible events that would delay the patrolling units; and
generate a patrol schedule for each patrolling unit using a Bayesian Stackelberg game theory model based on the map of the public transportation system, the schedule of the transports, the list of the one or more patrolling units, the probability distribution for the occurrence of the passenger not paying to ride the transports, the list of the one or more possible events that would delay the patrolling units, the probability distribution for the occurrence of the one or more possible events that would delay the patrolling units, wherein the probability distribution for the occurrence of the one or more possible events that would delay the patrolling units is represented by a Markov-decision process.

2. The medium of claim 1, wherein the probability distribution for the occurrence of the one or more possible events that would delay the patrolling units include at least one of: missing a scheduled transport, responding to a call to a different location in the transportation system, issuing a citation for an illegal behavior, and responding to an emergency.

3. The medium of claim 1, wherein the schedule of the transports incorporates a probability of delays of the transports.

4. The medium of claim 1, wherein the probability distribution for the occurrence of the passenger not paying to ride the transports is dependent on a time of a day and the day of the week.

5. The medium of claim 1, wherein the probability distribution for the occurrence of the one or more possible events that would delay the patrolling units is dependent on a time of a day and the day of the week.

6. The medium of claim 1, wherein the public transportation system is a passenger train system.

7. A non-transitory, tangible, computer-readable storage medium containing a program of instructions that cause a computer system running the program of instructions to:
receive a map of an area to be patrolled, a list of patrolling units available for patrolling the area, a description of maneuverability of each of the patrolling units, a description of a possible attack or attacks, a list of routes for an attacker corresponding to each possible attack, a probability distribution for each possible attack and corresponding routes for the attacker, a list of one or more possible events that would delay the patrolling units during a patrol, a probability distribution for an occurrence of the one or more possible events that would delay the patrolling units; and
generate a patrol schedule for each patrolling unit using a Bayesian Stackelberg game theory model based on the map of the area, the list of patrolling units, the description of maneuverability of each of the patrolling units, the description of the possible attack or attacks, the list of routes for the attacker corresponding to each possible attack, the probability distribution for each possible attack and corresponding routes for the attacker, the list of the one or more possible events that would delay the patrolling units, the probability distribution for the occurrence of the one or more possible events that would delay the patrolling units, wherein the probability distribution for the occurrence of the one or more possible events that would delay the patrolling units is represented by a Markov-decision process.

8. The medium of claim 7, wherein the Bayesian Stackelberg game theory model allows for the attacker to observe the patrolling units.

9. The medium of claim 7, wherein the one or more possible events that would delay the patrolling units include at least one of: missing a scheduled transport along a patrol schedule, responding to a call to a different location in the system, and responding to an emergency.

10. The medium of claim 7, wherein the area is an outdoor area and the attacker includes at least one of: a poacher, an illegal fisherman, or a person illegally cutting down trees.
